(19) United States
(12) Patent Application Publication
(10) Pub. No.: US 2023/0021659 A1
(43) Pub. Date: Jan. 26, 2023

(54) SHARED USE OF ALLOCATED WIRELESS CHANNELS IN A WIRELESS NETWORK

(71) Applicant: Charter Communications Operating, LLC, St. Louis, MO (US)

(72) Inventors: Abdulrauf Hafeez, Cary, NC (US); Maulik V. Vaidya, Escondido, CA (US)

(21) Appl. No.: 17/380,353

(22) Filed: Jul. 20, 2021

(51) Int. Cl. H04W 72/10; H04W 72/04; H04W 24/08; H04W 56/00

(52) U.S. Cl. CPC H04W 72/10; H04W 72/0446; H04W 24/08; H04W 56/001

(57) ABSTRACT

According to one configuration, a wireless network is shared amongst a hierarchal tier of users. The wireless network environment includes communication management hardware operative to receive notice of a first wireless channel allocated for use; the first wireless channel is allocated for use by the first wireless station and a second wireless station. During operation, the communication management hardware monitors use of the first wireless channel by one or more other wireless stations (such as including the second wireless station). Based on the monitored use, the controller controls wireless communications from the second wireless station.

### BACKGROUND

Conventional wireless networks typically include one or more wireless base stations to provide mobile communication devices access to a remote network such as the Internet.

One type of wireless base station is a so-called CBSD (Citizen Broadband Radio Service Device). Such a device uses a wireless channel allocated from a CBRS (Citizens Band Radio Service) band to support communications with one or more mobile communication devices.

Typically, so-called SAS (Spectrum Access Service) in a CBRS network allocates one or more wireless channels to a CBSD (such as a wireless base station) to support communications with respective user equipment such as one or more mobile communication devices. Each base station can be configured to communicate with the SAS to receive notification of the one or more wireless channels allocated for its use. Controlled allocation of wireless channels by the spectrum access system helps to prevent interference by wireless stations sharing use of the same spectrum.

There are multiple different types of wireless channels in a conventional CBRS band. For example, portions of spectrum in a CBRS band include so-called Priority Access License (PAL) wireless channels, General Authorized Access (GAA) wireless channels, or a combination of both.

In general, PAL wireless channels are licensed wireless channels in which a corresponding licensee (such as an entity paying for use of the wireless channel) is provided some protection of use. For example, when no incumbent user requires use of the channels, in theory, the licensed entity is able to freely use the PAL wireless channels in respective one or more predetermined geographical regions without interference by other lower priority entity users (such as lower priority GAA users).

Subsequent to allocation of one or more wireless channels, the wireless base stations use the allocated spectrum to provide one or more communication devices access to a remote network such as the Internet.

### BRIEF DESCRIPTION OF EMBODIMENTS

There are deficiencies associated with conventional techniques of providing wireless services to mobile communication devices. For example, a wireless station may be allocated use of a wireless channel exclusive of other wireless stations using the allocated wireless channel. If the wireless station does not use the allocated wireless channel to its fullest potential, such as by transmitting in every time slot assigned to the wireless station, the unused wireless bandwidth is wasted. Thus, conventional techniques can result in inefficient use of allocated wireless bandwidth when a respective wireless station is allocated a wireless channel and does not use it.

Embodiments herein provide improved use of wireless spectrum, promoting more efficient use of wireless channels amongst licensed and unlicensed wireless network service providers in a wireless network environment.

For example, a wireless system (wireless network environment) is shared amongst a hierarchal tier of users. A second wireless station amongst multiple wireless stations in the network environment includes communication management hardware operative to receive notice of a first wireless channel also allocated for use by a first wireless station. The first wireless channel is primarily allocated for use by the first wireless station, even though the first wireless channel is also allocated for use by the second wireless station (secondary user). During operation, the communication management hardware (such as associated with a respective wireless station) monitors use of the first wireless channel by one or more other wireless stations (such as including the second wireless station). Based on the monitored use, such as whether another wireless station uses the first wireless channel, the communication management hardware of the second wireless station controls wireless communications from the second wireless station.

As further discussed herein, the first wireless station can be assigned a highest priority level of using the allocated first wireless channel without the need to apply a listen before talk protocol to use the first wireless channel. Multiple wireless stations such as the second wireless station as well as a third wireless station, fourth wireless station, etc., can be allocated use of the first wireless channel as secondary (lower priority) users that are able to use the first wireless channel if it is not currently used by the first wireless station or another wireless station. The first wireless station in this example is assigned a higher priority than the second wireless station (or other wireless stations such as the third wireless station, fourth wireless station, etc.) to use the first wireless channel.

In further example embodiments, the communication management hardware associated with the second wireless station as discussed herein prevents wireless transmission of a first communication from the first wireless station in response to detecting use of the first wireless channel by another wireless station. Conversely, the communication management hardware as discussed herein wirelessly transmits one or more communications from the second wireless station in response to detecting non-use of the first wireless channel by another wireless station.

In one embodiment, the first wireless channel is allocated from a tiered hierarchy of wireless channels in which different service providers are assigned different usage priority levels of the wireless channels. Some of the wireless channels are exclusively allocated to wireless stations while other wireless channels of the hierarchy are shared by multiple wireless stations in a manner as discussed herein.

Determination of whether the first wireless channel is used by another wireless station can be achieved in any suitable manner. For example, in one embodiment, the communication management hardware as discussed herein monitors a power level (such as via detection of wireless energy) of receiving communications over the first wireless channel. The communication management hardware compares the power level (such as detected energy) to a threshold level. The communication management hardware then wirelessly transmits a communication from the second wireless station over the first wireless channel in response to detecting that the power level is below the threshold level.

In further example embodiments, the wireless monitor hardware as discussed herein synchronizes the second wireless station to a time-division time slot configuration frame also used by the first wireless station. This enables the communication management hardware of the second wireless station to determine timing of different timeslots used by the first wireless station to support communications in an uplink or downlink direction.

In still further example embodiments, the communication management hardware associated with the second wireless station implements monitoring via a random back-off time during a time slot of a time-division time slot configuration implemented by the first wireless station to communicate over the first wireless channel.

In yet further example embodiments, the communication management hardware associated with the second wireless station detects presence of energy in the first wireless channel above a threshold level in a first portion of a time slot. Control of wireless communications from the second wireless station based on the monitored use includes: via the communication management hardware associated with the second wireless station, in response to detecting presence of the energy in the first wireless channel above the threshold level in the first portion of the time slot, preventing communications over the first wireless channel during the first portion of the time slot.

The communication management hardware also detects a condition in which energy (or detected wireless power) in the first wireless channel is below a threshold level in a second portion of the time slot. In response to detecting presence of the wireless energy in the first wireless channel below the energy threshold level in the second portion of the time slot, the communication management hardware transmits a wireless communication over the first wireless channel during the second portion of the time slot.

### Additional Embodiments

Still further example embodiments herein include a system including an allocation management resource that allocates wireless channels to wireless stations in a network environment. The allocation management resource receives a communication from a second wireless station requesting allocation of bandwidth. The allocation management resource determines (detects) availability of a first wireless channel that is already allocated for use by a first wireless station. The first wireless channel supports shared use by the first wireless station and the second wireless station. In one embodiment, to provide better use of the wireless channel, the allocation management resource allocates the first wireless channel for use by the second wireless station (such as secondary user) while the first wireless channel is also allocated for use by the first wireless station (such as primary user).

In still further example embodiments, the communication management hardware allocates the first wireless channel from a tiered hierarchy of wireless channels in which different service providers are assigned different usage priority levels of the wireless channels. The first wireless station is assigned a higher priority than the second wireless station to use the first wireless channel. In such an instance, the second wireless station is able to use the first wireless channel when it is not used by another wireless station such as the first wireless station.

In further example embodiments, the allocation management resource or other suitable entity provides notification to the second wireless station of a time-division configuration frame include multiple timeslots implemented by the first wireless station to communicate over the first wireless channel. In such an instance, the second wireless station is aware of timing (such as timeslots) associated with the first wireless station using the first wireless channel to communicate in the wireless network environment.

In yet further example embodiments, the allocation management resource allocates the first wireless channel to the second wireless station in response to detecting that the second wireless station supports wireless power monitoring of the first wireless channel. For example, in one embodiment, the second wireless station is configured to support a mode of monitoring wireless communications from other wireless stations. In such an instance, the first wireless station is allocated use of the same wireless channel allocated to another wireless station. As previously discussed, the second wireless station uses the first wireless channel when it is not used by the first wireless station.

Thus, embodiments herein provide novel ways of providing more efficient use of wireless bandwidth. For example, both a first wireless station and a second wireless station can be allocated shared use of the same wireless channel. The first wireless station may be granted higher priority usage rights with respect to the first wireless channel. During times in which the first wireless channel is not used by the first wireless station having higher priority usage rights, the second wireless station uses the first wireless channel. As further discussed herein, additional wireless stations such as third wireless station, fourth wireless station, etc., can be allocated use of the first wireless channel as well. When the first wireless channel is not used by the first wireless station, the multiple wireless stations (such as second wireless station, third wireless station, fourth wireless station, etc.) compete amongst each other to use the first wireless channel.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, executable instructions, etc., that supports operations as discussed herein.

One embodiment includes a computer readable storage medium and/or system having instructions stored thereon to facilitate wireless communications in a network environment. The instructions, when executed by computer processor hardware, cause the computer processor hardware (such as one or more co-located or disparately processor devices) to: receive notice of a first wireless channel allocated for use, the first wireless channel allocated for use by a first wireless station and a second wireless station; monitor use of the first wireless channel; and control wireless communications from the second wireless station based on the monitored use.

Another embodiment includes a computer readable storage medium and/or system having instructions stored thereon to facilitate wireless communications in a network environment. The instructions, when executed by computer processor hardware, cause the computer processor hardware (such as one or more co-located or disparately processor devices) to: receive a communication requesting allocation of bandwidth; detect availability of a first wireless channel allocated for use by a first wireless station; and allocate the first wireless channel for use by a second wireless station while the first wireless channel is also allocated for use by the first wireless station.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless services to communication devices. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment implementing hierarchical wireless spectrum allocation and shared use of certain wireless channels according to embodiments herein.

FIG. 2 is an example diagram illustrating allocation of available wireless channels during non-detection of an incumbent entity according to embodiments herein.

FIG. 3 is an example diagram illustrating multiple different time-division duplex frame configurations according to embodiments herein.

FIG. 4 is an example diagram illustrating shared use of a wireless channels according to embodiments herein.

FIG. 5 is an example diagram illustrating shared use of a wireless channel according to embodiments herein.

FIG. 6 is an example diagram illustrating shared use of a wireless channel according to embodiments herein.

FIG. 7 is an example diagram illustrating shared use of a wireless channel according to embodiments herein.

FIG. 8 is an example diagram illustrating allocation of spectrum from a CBRS (Citizen Band Radio Service) and change in allocation according to embodiments herein.

FIG. 9 is an example diagram illustrating a wireless network environment implementing hierarchical wireless spectrum allocation and shared use of certain wireless channels according to embodiments herein.

FIG. 10 is an example diagram illustrating shared use of a wireless channel according to embodiments herein.

FIG. 11 is an example diagram illustrating implementation of random back-off times and clear channel assessment by one or more wireless stations according to embodiments herein.

FIG. 12 is a diagram illustrating example computer architecture to execute one or more operations according to embodiments herein.

FIG. 13 is an example diagram illustrating a method according to embodiments herein.

FIG. 14 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

In a shared time-division duplex (a.k.a., TDD) band such as CBRS, the available shared bandwidth is divided among all operators' devices in a given area for general authorized access or GAA. In dense areas, or in the vicinity of incumbents, each operator may only get a small amount of spectrum (e.g. 5 or 10 MHz) for its devices, which may not be enough for its needs. For example, the spectrum access system (SAS) may allocate additional GAA spectrum (aka bandwidth expansion) to a wireless service provider, but there may still be a portion of unused spectrum due to one or more of the following conditions: i) conservative propagation loss models employed by SAS may limit spectrum availability, ii) spectrum may not be fully used by all operators.

Furthermore, operators (a.k.a., wireless network service providers) may be limited by the SAS (Spectrum Access System) to using one of a few TDD configurations, which may not support their use cases. This results in an inefficient use of Uplink-Downlink wireless resources (such as bandwidth, channels, etc.).

The methods, systems, etc., as described herein allow an operator's devices to dynamically use wireless channels such as GAA spectrum that has been allocated to other operator's devices using conventional TDD access when they are not using them.

Coexistence with devices using conventional TDD access is ensured by means of a novel channel sensing (CS) functionality.

Priority Access License (PAL) holders purchase wireless licenses and reserve the right to use them in corresponding pre-determined geographical areas of operation. If there are PAL operators in a CBRS network, the main purpose of SAS (Spectrum Access System) is to protect these PAL holders (licensed wireless network service providers) from the interference generated by other users in the network.

Thus, according to embodiments herein, a wireless network is shared amongst a hierarchal tier of users. The wireless network includes communication management hardware (associated with a first wireless station) to receive notice of a first wireless channel allocated for use by a first wireless station. The first wireless channel is primarily allocated for use by a second wireless station, even though the first wireless channel is simultaneously allocated for use by the first wireless station (primary user) and the second wireless station (secondary user).

During operation, and use of the first wireless channel, the communication management hardware associated with the first wireless station monitors use of the first wireless channel by one or more other wireless stations (such as including the second wireless station). Based on the monitored use, such as whether another wireless station uses the first wireless channel, the communication management hardware (secondary user) controls wireless communications from the first wireless station in the wireless network environment. For example, as previously discussed, if the first wireless channel is used by another wireless station, the wireless base station does not use the wireless channel. If the first wireless channel is not used by another wireless station, the wireless base station communicates a wireless message using the wireless channel. Thus, even though a channel is primarily allocated for use by a second wireless station, a first wireless station (secondary user of the fit wireless channel) may use the wireless channel when it is not used by the second wireless station.

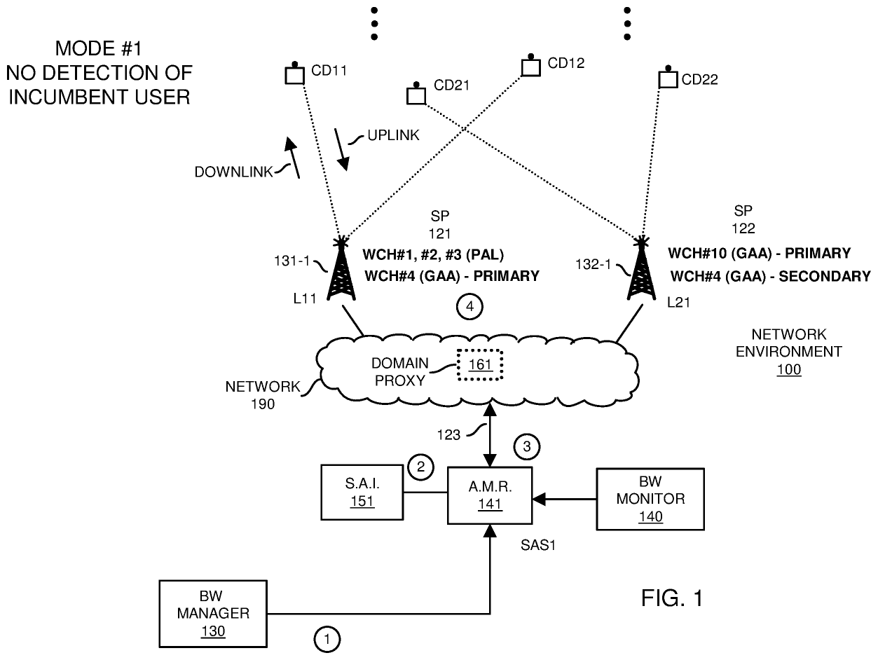

Now, more specifically, FIG. 1 is an example diagram illustrating a hierarchical wireless network implementing allocation and use of wireless bandwidth according to embodiments herein.

As shown in this example embodiment, network environment 100 includes bandwidth manager 130, bandwidth monitor 140, allocation management resource 141 (communication management resource such as spectrum access system SAS1), network 190 (such as including one or more of the Internet, wireless infrastructure, cellular system, wireless access network, etc.), and wireless stations such as wireless base station 131-1, wireless base station 131-2, . . . , wireless station CD11 (end user device, mobile communication device, communication device, etc.), wireless station CD12, wireless station CD21, wireless station CD22, etc.

In one embodiment, the network 190 includes one or more domain proxies 161 that facilitate communications between the allocation management resources and the wireless base stations. For example, allocation management resource 141 and wireless stations 131-1, 131-2, etc., can communicate directly with each other over network 190 or through domain proxy 161.

Note that each of the resources (such as wireless stations, communication devices, allocation management resources, spectrum monitor, spectrum manager, etc.) in network environment 100 can be configured to include appropriate hardware, software, or combination of hardware and software to carry out respective operations as discussed herein.

More specifically, bandwidth manager 130 can be configured as bandwidth manager hardware, bandwidth manager software, or a combination of bandwidth manager hardware and bandwidth manager software; bandwidth monitor 140 can be configured as bandwidth monitor hardware, bandwidth monitor software, or a combination of bandwidth monitor hardware and bandwidth monitor software; allocation management resource 141 can be configured as allocation management hardware, allocation management software, or a combination of allocation management hardware and allocation management software; wireless station 131-1 can be configured as wireless station hardware, wireless station software, or a combination of wireless station hardware and wireless station software; wireless station 132-1 can be configured as wireless station hardware, wireless station software, or a combination of wireless station hardware and wireless station software; and so on.

Note that the resources as discussed herein can be implemented in any suitable manner and at any suitable location.

Each communication device (such as CD11, CD12, CD21, CD22, etc.) is mobile or stationary with respect to a wireless station providing it access to network 190. In one embodiment, as previously mentioned, network 190 includes the Internet or other networks.

As further shown, wireless station 131-1 (such as a wireless base station operated by a first wireless network service provider 121/operator) is disposed at location L11 providing communication devices CD11, CD12, etc., access to network 190; wireless station 131-2 (such as a wireless base station operated by the first wireless network service provider/operator) is disposed at location L12, and so on. Network environment 100 includes any suitable number of wireless stations.

Further in this example embodiment, wireless station 132-1 (such as a wireless base station operated by a second wireless network service provider 122/operator) is disposed at location L21 providing communication devices CD21, CD22, etc., access to network 190; wireless station 132-2 (such as operated by the second wireless network service provider/operator) is disposed at location L22, and so on.

In this example embodiment, note that an incumbent user (first-priority tier 1 user) has highest priority rights to use all wireless channels.

For example, in one embodiment, the allocation management resource 141 allocates wireless channels from a tiered hierarchy in which the incumbent user has highest priority rights. As its name suggests, the bandwidth monitor 140 (such as an ESC or Environmental Sensing Capability) monitors for use of the wireless channels 1-10 by a respective one or more incumbent entity. If the bandwidth monitor 140 detects use of any of the one or more wireless channels by a higher priority user, the bandwidth monitor 140 notifies the allocation management resource 141 of this condition. In response to detecting the condition of the incumbent user using a respective one or more wireless channel, the allocation management resource 141, in turn, notifies (such as immediately or within a short timeframe such as a few minutes) appropriate wireless stations (and corresponding wireless network service providers) to discontinue use of such wireless channels.

In one embodiment, each of the one or more allocation management resources in the network environment 100 individually or collectively keeps track of a respective location of each of the wireless stations and allocates wireless channels such that two or more wireless stations implementing wireless communications do not interfere with each other. For example, in one embodiment, in furtherance of providing protected use of allocated bandwidth, the allocation management resources allocate different wireless channels to wireless stations that are in the same location or geographical region.

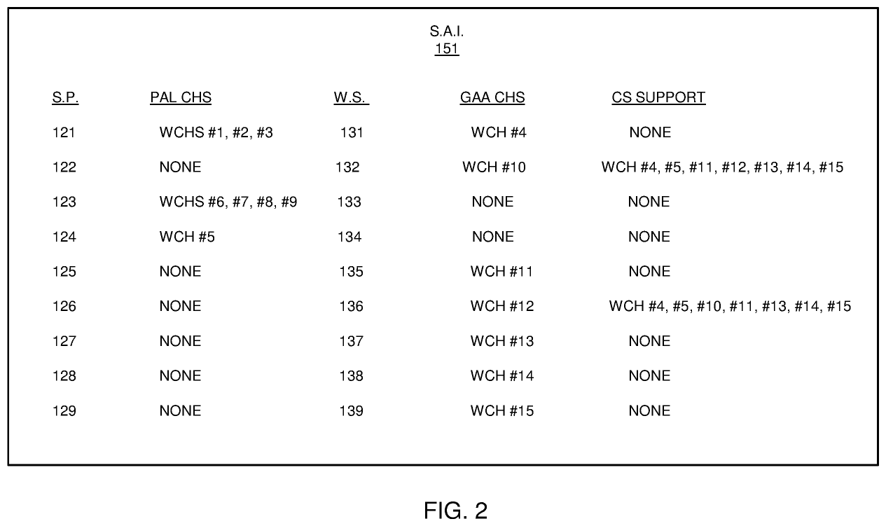

During further operation, note that the bandwidth manager 130 initially produces spectrum allocation information 151 indicating assignment of bandwidth (one or more PAL wireless channels) such as determined from results of a bandwidth auction in which operators pay license fees for use of one or more of wireless channels 1-10. Certain wireless channels are allocated to GAA users. An example of such as is shown in FIG. 2.

FIG. 2 is an example diagram illustrating assignment, allocation, and use of available wireless channels during non-detection of an incumbent entity according to embodiments herein.

As previously discussed, the wireless stations in network environment 100 can be operated by any number of multiple different service providers. For example, in one embodiment, as indicated by the spectrum allocation information 151 managed by the allocation management resource 141 or other suitable entity, the first wireless station 131-1 and potentially one or more other wireless stations are operated by a first wireless network service provider 121 (second-priority tier 2 user or PAL user assigned use of PAL wireless channels #1, #2, and #3 as well as supplemental GAA wireless channel #4); the first wireless network service provider 121 has a license (such as via paying a license fee) to use the first wireless spectrum (PAL wireless channels #1, #2, and #3) to communicate with respective communication devices CD11, CD12, etc.

As further indicated by the spectrum allocation information 151 managed by the allocation management resource 141 or other suitable entity, the second wireless station 132-1 and potentially one or more other wireless stations are operated by a second wireless network service provider 122 (third-priority tier 3 user or GAA user not assigned use of any PAL wireless channels but is assigned use of GAA wireless channel #10); the second wireless network service provider 122 is not assigned any PAL wireless channels.

The one or more third wireless stations 133 are operated by a third wireless network service provider 123 (second-priority tier 2 user or PAL user assigned use of PAL wireless channels #6, #7, #8, and #9); the third wireless network service provider 123 has a license (such as via paying a license fee) to use the first wireless spectrum (PAL wireless channels #6, #7, #8, and #9).

The one or more fourth wireless stations 134 are operated by a fourth wireless network service provider 124 (third-priority tier 3 user or GAA user not assigned use of any PAL wireless channels but is assigned use of GAA wireless channel #5).

The fifth wireless stations 135 are operated by a fifth wireless network service provider 125 (third-priority tier 3 user or GAA user not assigned use of any PAL wireless channels but is assigned use of GAA wireless channel #11).

The sixth wireless stations 136 are operated by a sixth wireless network service provider 126 (third-priority tier 3 user or GAA user not assigned use of any PAL wireless channels but is assigned use of GAA wireless channel #12).

The seventh wireless stations 137 are operated by a sixth wireless network service provider 127 (third-priority tier 3 user or GAA user not assigned use of any PAL wireless channels but is assigned use of GAA wireless channel #13).

The eighth wireless stations 138 are operated by an eighth wireless network service provider 128 (third-priority tier 3 user or GAA user not assigned use of any PAL wireless channels but is assigned use of GAA wireless channel #14).

The ninth wireless stations 139 are operated by a ninth wireless network service provider 129 (third-priority tier 3 user or GAA user not assigned use of any PAL wireless channels but is assigned use of GAA wireless channel #15).

As further shown, the spectrum allocation information 151 indicates which of the one or more service providers and/or corresponding wireless stations support shared use of wireless channels (such as GAA wireless channels). The allocation management resource 141 can be configured to receive such information from any suitable entity such as from the wireless stations, service providers, etc.

As further discussed herein, the spectrum allocation information 151 indicates that the service provider 122 and/or corresponding wireless stations 132 support channel sensing (channel monitoring in wireless channels 4, 5, 11, 12, 13, 14, 15) to use available one or more full unused portion or less-than-all portion of time slots not used by another wireless station. The spectrum allocation information 151 indicates that the service provider 126 and/or corresponding wireless stations 136 support channel sensing (channel monitoring in wireless channels 4, 5, 10, 11, 13, 14, 15) to use available one or more full unused portion or less-than-all portion of time slots not used by another wireless station.

Referring again to FIG. 1, in processing operation #1, the bandwidth manager 130 distributes the spectrum allocation information 151 to the spectrum allocation management resource 141 (such as SAS1).

In processing operation #2, the allocation management resource 141 stores and updates the spectrum allocation information 151.

Further in this example embodiment, in processing operation #3, via communication 123 over network 190 to wireless stations 131-1, 132-1, etc., the allocation management resource 141 allocates use of the wireless bandwidth (wireless channels) in accordance with the spectrum allocation information 151.

For example, the wireless base station 131-1 initially registers with the allocation management resource 141 for use of wireless channels. As previously discussed, in accordance with the spectrum allocation information 151, because no incumbent entity is present in the network environment 100, the allocation management resource 141 allocates use of wireless channels #1, #2, and #3 (such as PAL wireless channels) to the wireless base stations 131-1 at location L11. The allocation management resource 141 also assigns uses of supplemental GAA wireless channel #4 to the wireless station 131-1 and corresponding service provider 121.

In this example embodiment, the wireless channel #4 is allocated in accordance with a hierarchical tier. For example, the wireless station 131-1 and corresponding service provider 121 are assigned as a primary user of the wireless channel #4. As a primary user, the corresponding service provider 121 and wireless station 131-1 have higher priority rights to use the wireless channel #4 than secondary users as further discussed below.

As previously discussed, note again that the network 190 can be configured to include one or more domain proxy 161 through which the wireless base stations 131-1 communicates with the allocation management resource 141. In a reverse direction, the allocation management resource 141 communicates through the domain proxy 161 to the wireless base station 131-1. Alternatively, note that the wireless base stations 131 and the allocation management resource 141 transmit communications directly to each other without use of the domain proxy 161 as an intermediary resource.

Additionally, the wireless base station 132-1 operated by the second wireless network service provider 122 registers with the allocation management resource 141 for use of wireless channels. Because no incumbent entity is present, the allocation management resource 141 allocates use of wireless channel #10 to the wireless base station 132-1 and corresponding service provider 122. The wireless station 132-1 or other suitable entity notifies the allocation management resource 141 that it (and corresponding mobile communication device (CD21, CD22, etc.) supports channel sensing and monitoring (such as listen before talk, clear channel assessment, etc.) on wireless channels #4, #5, #11, #12, #13, #14, and #15. The wireless station 132-1 is therefore a candidate to share use of one or more of these GAA wireless channels assigned to one or more other wireless stations (or service providers).

Thus, in one embodiment, the wireless station 132-1 registers with a spectrum access system (SAS) indicating its channel sensing capability. In such an instance, because the wireless station 132-1 requests additional bandwidth, and because it supports channel sensing on wireless channel #4, the allocation management resource 141 also assigns use of GAA wireless channel #4 to the wireless station 132-1 (as a secondary user) and corresponding service provider 122.

In this example embodiment, as previously discussed, the wireless channel #4 itself is allocated in accordance with a tiered hierarchy. For example, the wireless station 132-1 and corresponding service provider 122 are assigned as a secondary user of the wireless channel #4. As a secondary user, as further discussed herein, the corresponding service provider 122 and wireless station 132-1 have lower priority rights to use the wireless channel #4 than primary user (such as service provider 121 and wireless station 131-1). Accordingly, embodiments herein include implementing a multiple level tiered hierarchy. In other words, as further discussed herein, the secondary user (i.e., corresponding service provider 122 and wireless station 132-1) are able to use the wireless channel #4 only if it is not used by the service provider 121 and corresponding wireless station 131-1. Neither wireless station 131-1 nor wireless station 132-2 can use the wireless channel #4 when it is used by an incumbent entity.

In one embodiment, the allocation management resource 141 receives feedback from wireless stations indicating actual usage of each of the allocated wireless channels. The allocation management resource uses the usage information as a basis to identify which wireless channels are good candidates to share amongst multiple users. For example, in one embodiment, the allocation management resource 141 detects from received feedback that the wireless channel #4 is not fully used by the primary wireless station 131-1. In such an instance, because the wireless channel #4 is not fully used by the wireless station 131-1 and corresponding service provider 121, the allocation management resource 141 allocates use of the wireless channel #4 to the wireless station 132-1 and wireless station 136-1. In comparison, wireless channel #11 may be fully used by the service provider 125 and corresponding wireless stations 135 to transmit data in which there are no free timeslots. In such an instance, the wireless channel #11 is not a good candidate to implement sharing as discussed herein.

Further in this example embodiment, note that an incumbent user/entity (such as a naval vessel implementing RADAR use of one or more wireless channels) is a first-priority tier 1 user in the priority hierarchy, the PAL users are second-priority tier 2 users in the priority hierarchy, and the GAA users are third-priority tier 3 users in the priority hierarchy. In the hierarchy, the incumbent users have highest priority access rights; the PAL users have second highest priority access rights; the GAA users have the lowest priority access rights.

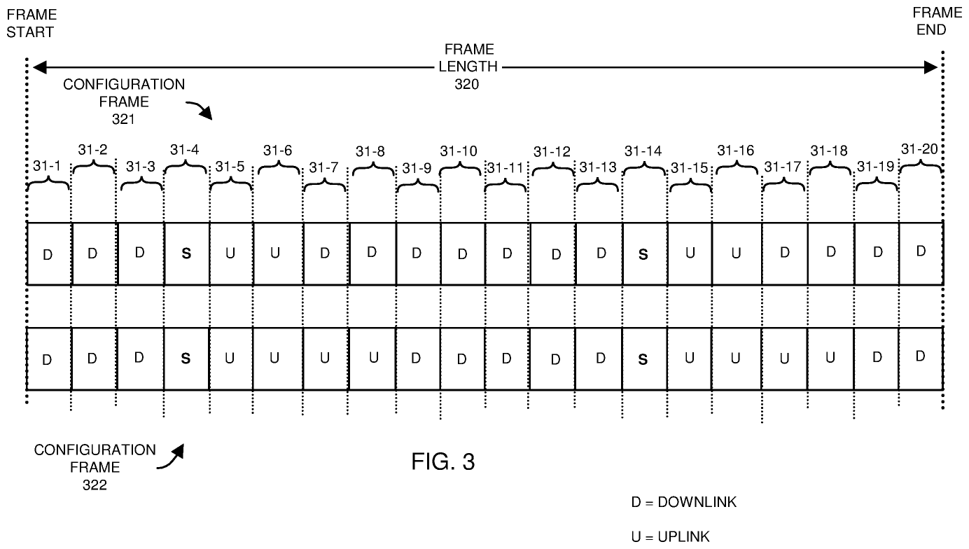

FIG. 3 is an example diagram illustrating multiple different frame configurations according to embodiments herein.

In one embodiment, the allocation management resource 141 or other suitable entity notifies the respective wireless stations in wireless network environment 100 which of multiple possible time-division duplex configuration frames (such as configuration frame 321 or configuration frame 322) of frame length 320 to implement with respect to use of allocated wireless channels.

As shown, the configuration frame 321 includes multiple timeslots allocated to support downlink (communications from the wireless station 131-1 to the communication devices CD11, CD12, etc.) or uplink communications (communications from the communication devices CD11, CD12, etc., to the wireless station 131-1).

For example, for configuration frame 321: time slot 31-1 is allocated to support downlink communications; time slot 31-1 is allocated to support downlink communications; time slot 31-1 is allocated to support downlink communications; time slot 31-2 is allocated to support downlink communications; time slot 31-3 is allocated to support downlink communications; time slot 31-4 is a special time slot allocated to support uplink or downlink communications; time slot 31-5 is allocated to support uplink communications; time slot 31-6 is allocated to support uplink communications; time slot 31-7 is allocated to support downlink communications; time slot 31-8 is allocated to support downlink communications; time slot 31-9 is allocated to support downlink communications; time slot 31-10 is allocated to support downlink communications; time slot 31-11 is allocated to support downlink communications; time slot 31-12 is allocated to support downlink communications; time slot 31-13 is allocated to support downlink communications; time slot 31-14 is a special time slot allocated to support uplink or downlink communications; time slot 31-15 is allocated to support uplink communications; time slot 31-16 is allocated to support uplink communications; time slot 31-17 is allocated to support downlink communications; time slot 31-18 is allocated to support downlink communications; time slot 31-19 is allocated to support downlink communications; time slot 31-20 is allocated to support downlink communications.

For configuration frame 322: time slot 31-1 is allocated to support downlink communications; time slot 31-1 is allocated to support downlink communications; time slot 31-2 is allocated to support downlink communications; time slot 31-3 is allocated to support downlink communications; time slot 31-4 is a special time slot allocated to support uplink or downlink communications; time slot 31-5 is allocated to support uplink communications; time slot 31-6 is allocated to support uplink communications; time slot 31-7 is allocated to support uplink communications; time slot 31-8 is allocated to support uplink communications; time slot 31-9 is allocated to support downlink communications; time slot 31-10 is allocated to support downlink communications; time slot 31-11 is allocated to support downlink communications; time slot 31-12 is allocated to support downlink communications; time slot 31-13 is allocated to support downlink communications; time slot 31-14 is a special time slot allocated to support uplink or downlink communications; time slot 31-15 is allocated to support uplink communications; time slot 31-16 is allocated to support uplink communications; time slot 31-17 is allocated to support uplink communications; time slot 31-18 is allocated to support uplink communications; time slot 31-19 is allocated to support downlink communications; time slot 31-20 is allocated to support downlink communications.

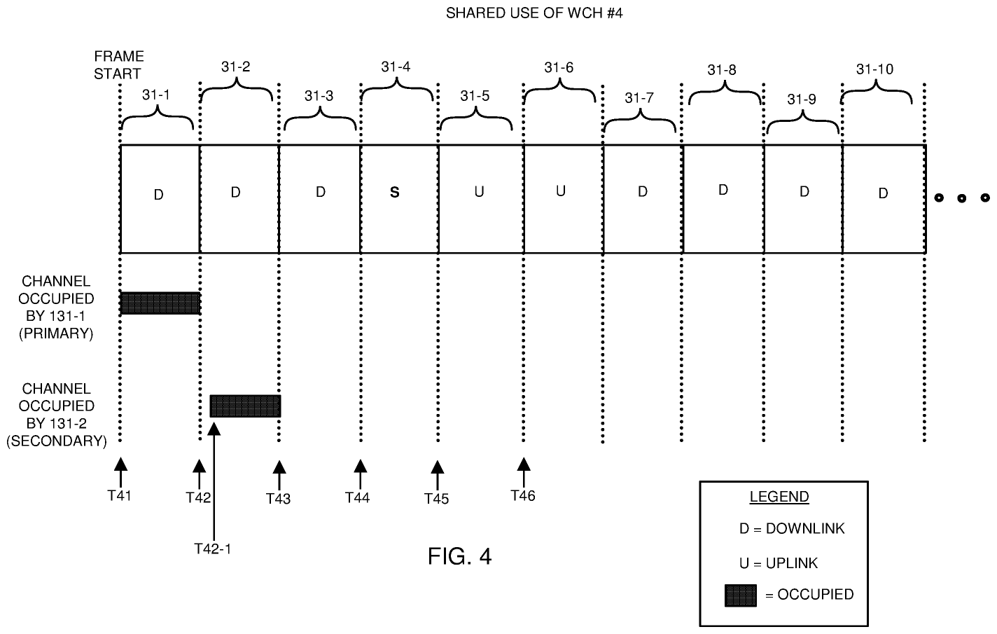

FIG. 4 is an example diagram illustrating shared use of a wireless channel according to embodiments herein.

As previously discussed, embodiments herein include allowing wireless stations such as wireless base stations (such as CBSDs) and its corresponding mobile communication devices (CDs) to dynamically share one or more channel(s). The wireless station 131-1 is assigned a higher priority to use the wireless channel #4 than the wireless station 132-1.

Assume in this example embodiment, that the allocation management resource 141 allocates use of the wireless channel #4 to both wireless station 131-1 (primary user) and wireless station 132-1 (secondary user). For example, in one embodiment, the wireless station 132-1 (such as a CBSD) sends the allocation management resource 141 a spectrum inquiry request. The allocation management resource 141 provides the wireless station 132-1 a spectrum inquiry response, which includes: i) any PAL and GAA channels available to the CBSD (for conventional TDD access) such as at least wireless channel #10 in which the wireless station 132-1 is a primary user; ii) GAA channels (such as at least wireless channel #4 and potentially wireless channels #4, #5, #11, #12, #13, #14, and #15) available to the CBSD only through channel sensing (CS). As previously discussed, wireless channel #4 is a channel that is occupied by at least one other GAA users (wireless station 131-1) but can be used dynamically when the other GAA users are not using it.

In one embodiment, the wireless station 132-1 informs the allocation management resource 141 that it intends to use wireless channel #4 as a secondary user. The allocation management resource 141 grants use of the wireless channel #4 to the wireless station 132-1 and corresponding service provider 122.

The wireless station 132-1 and corresponding mobile communication devices CD21, CD22, etc., employ clear channel assessment (CCA) (such as any suitable listen before talk algorithm) using energy detection (ED) as a basis of acquiring a channel and transmitting within slot boundaries (semi-slotted access) of the configuration frame.

In one embodiment, the ED threshold of determining whether it is OK to transmit may depend on the device (wireless station) transmit EIRP as follows:

−85+10*log 10 (BW)+P dBm, where BW is the channel bandwidth in MHz and P=23−Tx EIRP dBm

Note further that, initially, all of the wireless stations in network environment 100 synchronize with a respective master clock (such as provided by a GPS satellite or other suitable entity) such that they all implement the same configuration frame indicated by the allocation management resource 141 or other suitable entity. Assume in this example embodiment that the wireless stations 131-1 and 132-1 synchronize themselves to use the configuration frame 321 as shown in FIG. 4. As previously discussed, certain portions of the configuration frame 321 are allocated for downlink communications while other time slots are allocated for uplink communications.

Assume that the wireless station 131-1 and wireless station 131-2 both would like to use wireless channel #4 during the time slot 31-1 to transmit in a downlink direction.

As previously discussed, the wireless station 131-1 has highest priority use of the wireless channel #4. In such an instance, the wireless station 131-1 transmits its data in the downlink from the wireless station 131-1 to a mobile communication device CD11 (or other communication device) between time T41 and time T42. Because the wireless station 132-1 would like to transmit in time slot 31-1 as well, the wireless station 132-1 monitors use of the wireless channel #4 in time slot 31-1 between time T41 and time T42. When implementing listen before talk or clear channel assessment in the time slot 31-1, the wireless station 132-1 determines the magnitude of the energy. The wireless station 132-1 detects that the energy (power level) in wireless channel #4 is above the energy threshold level for a duration of the time slot 31-1 such as because the wireless station 131-1 is transmitting in the time slot 31-1. In this instance, the wireless station 132-1 therefore does not transmit because it is assigned a lower priority level than other wireless stations and the channel is used by another wireless station. In other words, the wireless station 132-1 prevents wireless transmission of communications from the wireless station 132-1 in the time slot 31-1 in response to detecting use of the wireless channel #4 by another wireless station such as wireless station 131-1.

Assume that the wireless station 131-1 does not transmit data in the downlink in time slot 31-2 because it has no data to transmit. The wireless station 131-2 would like to use wireless channel #4 during the time slot 31-2 to transmit in a downlink direction. The wireless station starts monitoring presence of energy in wireless channel #4 at time T42. Between time T42 and time T42-1, the wireless station 132-1 detects that the wireless energy in the wireless channel #4 is lower than the ED threshold level for a predetermined amount of time as indicated by the listen before talk algorithm implemented by the wireless station 132-1.

As previously discussed, the wireless station 132-1 is able to use the wireless channel #4 if not used by another wireless station. Because the wireless energy (a.k.a., wireless power level) detected in the wireless channel #4 is below the ED threshold level for greater than a predetermined amount of time between time T42 and T42-1, the wireless station 132-1 transmits its data (such as one or more data packets, symbols, etc.) in in the downlink on wireless channel #4 from time T42-1 to time T43. Thus, a time slot of wireless channel #4 that otherwise would not have been used by the wireless station 131-1 is used by wireless station 132-1.

Note that, in one embodiment, the primary wireless station (such as wireless station 131-1) assigned use of a respective shared (such as GAA) wireless channel must transmit at or around a beginning of the respective time slot in which it is going to transmit data. This ensures that the primary wireless station 131-1 does not cause a collision with data transmitted by the wireless station 132-1 between time T42-1 and time T43. One way to prevent collisions between transmitting wireless stations in the middle of the respective timeslots of configuration frame 321 is to require the primary wireless station (such as wireless station 131-1) to implement a listen before talk algorithm between time T42-1 and T43.

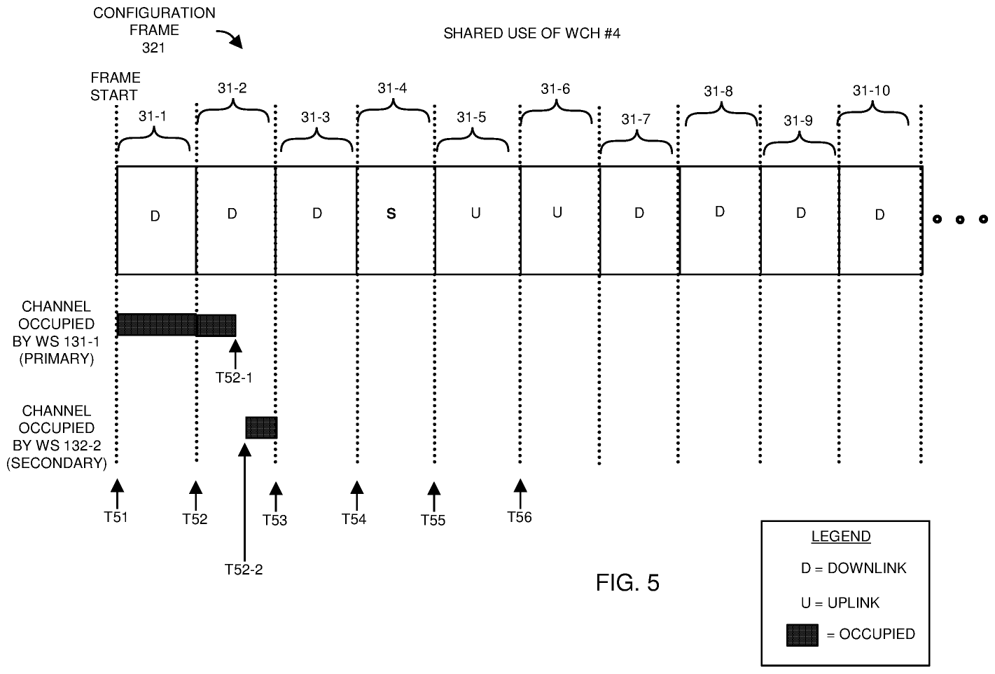

FIG. 5 is an example diagram illustrating shared use of a wireless channel according to embodiments herein.

In this example embodiment, service provider 121 operating wireless station 131-1 and service provider 122 operating wireless station 132-1 share use of wireless channel #4. For example, the allocation management resource 141 allocates use of the wireless channel #4 to both wireless station 131-1 (primary user) and wireless station 132-1 (secondary user). In a manner as previously discussed, both wireless station 131-1 and wireless station 132-1 are synchronized to share use of configuration frame 321.

Further, as previously discussed, the configuration frame 321 supports downlink communications from a wireless station to a mobile communication device during time slot 31-1.

Assume that the wireless station 131-1 and wireless station 131-2 both would like to use wireless channel #4 during the time slot 31-1 (between time T51 and time T52) to transmit in a downlink direction. As previously discussed, the wireless station 131-1 has highest priority use of the wireless channel #4. In such an instance, the wireless station 131-1 transmits its data in the downlink from the wireless station 131-1 to a mobile communication device CD11 (or other communication device) between time T51 and time T52. Because the wireless station 132-1 would like to transmit in time slot 31-1 as well, the wireless station 132-1 monitors use of the wireless channel #4 in time slot 31-1 between time T51 and time T52. When implementing listen before talk or clear channel assessment in the time slot 31-1, the wireless station 132-1 detects that the magnitude of the energy in wireless channel #4 is above the energy threshold level for a duration of the time slot 31-1 such as because the wireless station 131-1 is transmitting in the time slot 31-1 between time T51 and time T52. In this instance, the wireless station 132-1 therefore does not transmit because it is assigned a lower priority level than other wireless stations and because the channel #4 is used by another wireless station.

Assume that the wireless station 131-1 does transmit data in the downlink in a first portion of time slot 31-2. As previously discussed, the wireless station 132-1 would like to use wireless channel #4 during the time slot 31-2 to transmit in a downlink direction. The wireless station starts monitoring presence of energy in wireless channel #4 at time T52. Between time T52 and time T52-1, the wireless station 132-1 detects that the wireless energy in the wireless channel #4 is higher than the ED threshold level. Thus, in response to detecting presence of the energy in the first wireless channel above the threshold level in the first portion of the time slot 31-2 between T52 and T52-1, the wireless station 132-1 prevents transmission of wireless communications over the wireless channel #4 during the first portion of the time slot 31-2.

At time T52-1, the wireless station wireless station 131-1 stops transmitting in time slot 31-2. The wireless station 132-1 detects this condition and continues to monitor use of the wireless channel #4 after time T52-1. Starting from time T52-1, the wireless station 132-1 detects that the energy (or power level) of received wireless communications between time T52-1 and time T52-2 is below the ED threshold level for a predetermined amount of time associated with the listen before talk algorithm implemented by the wireless station 132-1 to monitor the wireless channel #4.

As previously discussed, the wireless station 132-1 is able to use the wireless channel #4 if not used by another wireless station. Because the wireless energy detected in the wireless channel #4 is below the ED threshold level for greater than a predetermined amount of time such as monitored between time T52-1 and T52-2, the wireless station 132-1 transmits its data (such as one or more data packets, symbols, etc.) in the downlink on wireless channel #4 from time T52-2 to time T53. Thus, a remaining portion of a time slot of wireless channel #4 (between T52-2 and T53) that otherwise would not have been used by the wireless station 131-1 is used by wireless station 132-1.

In other words, via embodiments herein, shared use of the wireless channel #4 enables both the wireless station 131-1 and wireless station 132-1 to transmit data in different respective portions of the time slot 31-2.

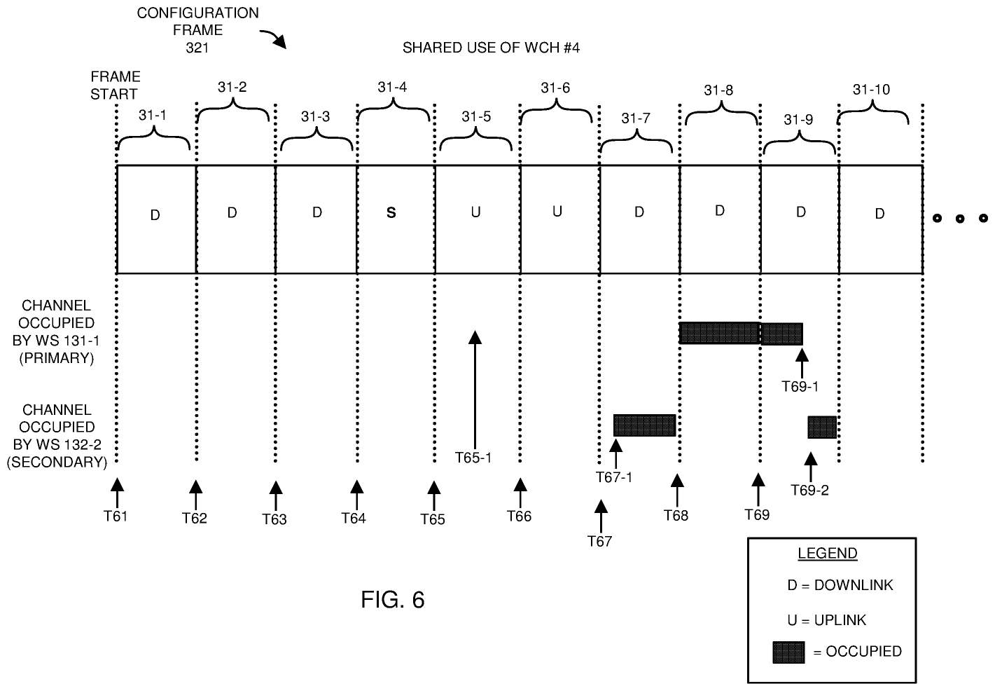

FIG. 6 is an example diagram illustrating shared use of a wireless channel according to embodiments herein.

As previously discussed, the allocation management resource 141 allocates use of the wireless channel #4 to both wireless station 131-1 (primary user) and wireless station 132-1 (secondary user). Both wireless station 131-1 and wireless station 132-1 are synchronized to share use of configuration frame 321.

At time T65-1, the wireless station 132-1 has data to communicate in the downlink to a respective mobile communication device. Because the time slot 31-5 and time slot 31-6 of the configuration frame 321 are uplink frames, the wireless station 132-1 is unable to transmit in the downlink in time slots 31-5 and time slot 31-6.

Assume that the wireless station 131-1 does not transmit data in the downlink in time slot 31-7. The wireless station 131-2 would like to use wireless channel #4 during the time slot 31-7 to transmit in a downlink direction. To this end, the wireless station 132-1 starts monitoring presence of energy in wireless channel #4 at time T67. Between time T67 and time T67-1, the wireless station 132-1 detects that the wireless energy in the wireless channel #4 is lower than the ED threshold level for a predetermined amount of time associated with the listen before talk algorithm implemented by the wireless station 132-1. As previously discussed, the wireless station 132-1 is able to use the wireless channel #4 if not used by another wireless station. Because the wireless energy detected in the wireless channel #4 is below the ED threshold level for greater than a predetermined amount of time associated with the implemented clear channel assessment algorithm implemented by the wireless station 132-1, the wireless station 132-1 transmits its data (such as one or more data packets, symbols, etc.) in in the downlink on wireless channel #4 from time T67-1 to time T68. Thus, a time slot of wireless channel #4 that otherwise would not have been used by the wireless station 131-1 is used by wireless station 132-1.

Assume that the wireless station 131-1 and wireless station 131-2 both would like to use wireless channel #4 during the time slot 31-8 (between time T68 and time T69) to transmit in a downlink direction. As previously discussed, the wireless station 131-1 has highest priority use of the wireless channel #4. In such an instance, without monitoring communications, the wireless station 131-1 transmits its data in the downlink from the wireless station 131-1 to a mobile communication device CD11 (or other communication device) between time T68 and time T69. Because the wireless station 132-1 would like to transmit in time slot 31-8 as well, the wireless station 132-1 monitors use of the wireless channel #4 in time slot 31-8 between time T68 and time T69. When implementing listen before talk or clear channel assessment in the time slot 31-8, the wireless station 132-1 detects that the magnitude of the energy in wireless channel #4 is above the energy threshold level for a duration of the time slot 31-8 such as because the wireless station 131-1 is transmitting in the time slot 31-8 between time T68 and time T69. In this instance, the wireless station 132-1 therefore does not transmit because it is assigned a lower priority level than other wireless stations and because the channel #4 is used by another wireless station.

Assume that the wireless station 131-1 does transmit data in the downlink in a portion of time slot 31-9. The wireless station 131-2 would like to use wireless channel #4 during the time slot 31-9 to transmit in a downlink direction. The wireless station starts monitoring presence of energy in wireless channel #4 at time T69. Between time T69 and time T69-1, the wireless station 132-1 detects that the wireless energy in the wireless channel #4 is higher than the ED threshold level. At time T69-1, the wireless station wireless station 131-1 stops transmitting in time slot 31-9. The wireless station 132-1 continues to monitor use of the wireless channel #4 after time T69-1. Starting from time T69-1, the wireless station 132-1 detects that the energy (or power level) of received wireless communications between time T69-1 and time T69-2 is below the ED threshold level for a predetermined amount of time associated with the listen before talk algorithm implemented by the wireless station 132-1.

As previously discussed, the wireless station 132-1 is able to use the wireless channel #4 if not used by another wireless station. Because the wireless energy detected in the wireless channel #4 is below the ED threshold level for greater than a predetermined amount of time (listen before talk time) such as detected between time T69-1 and T69-2, the wireless station 132-1 transmits its data (such as one or more data packets, symbols, etc.) in in the downlink on wireless channel #4 from time T69-2 to time T70. Thus, a remaining portion of a time slot of wireless channel #4 that otherwise would not have been used by the wireless station 131-1 is used by wireless station 132-1.

In other words, via embodiments herein, shared use of the wireless channel #4 enables both the wireless station 131-1 and wireless station 132-1 to transmit data in different respective portions of the time slot 31-9.

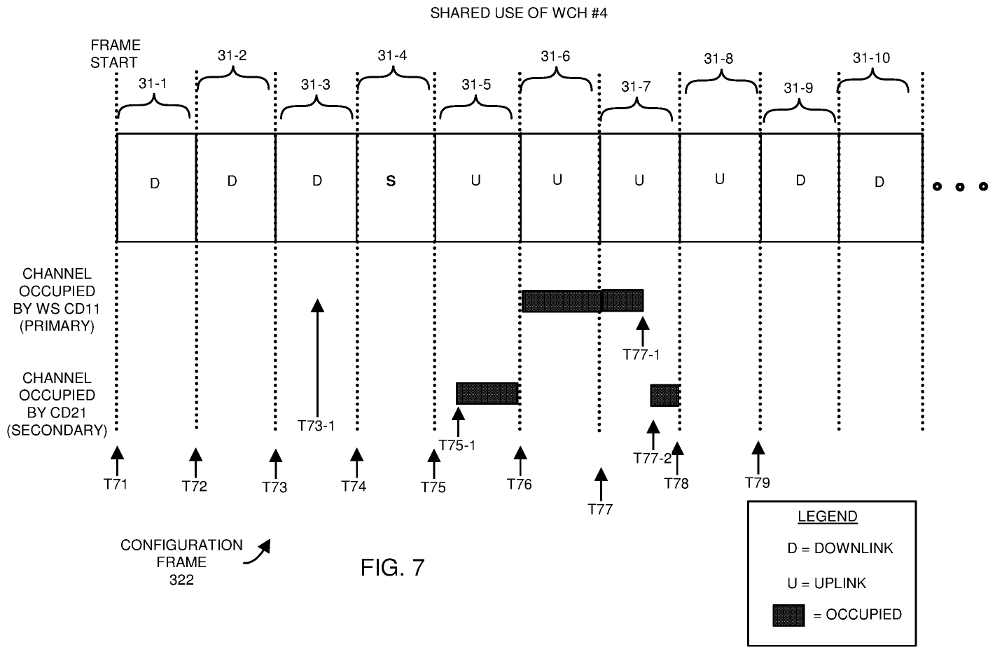

FIG. 7 is an example diagram illustrating shared use of a wireless channels according to embodiments herein.

As previously discussed, the configuration frame 322 also supports uplink communications from mobile communication devices to respective wireless stations. Service provider 121 supporting communications with mobile communication devices CD11, CD12, etc., and service provider 122 supporting communications with mobile communication devices CD21, CD22, etc., share use of wireless channel #4.

For example, the allocation management resource 141 allocates use of the wireless channel #4 to both wireless station 131-1 (as a primary user) and corresponding mobile communication devices and wireless station 132-1 (secondary user) and corresponding mobile communication devices. Both wireless station 131-1 and corresponding mobile communication devices and wireless station 132-1 and corresponding mobile communication devices are synchronized to share use of wireless channel #4 in accordance with time-division duplex time slot associated with configuration frame 322 in this example embodiment.

As previously discussed, the configuration frame 321 supports uplink and downlink communications.

At time T73-1, the mobile communication device CD21 has data to communicate in the uplink to wireless station 132-1. Because the time slot 31-3 and time slot 31-4 of the configuration frame 322 are not uplink frames, the mobile communication device CD21 is unable to transmit in the time slots 31-3 and time slot 31-4.

Assume that the mobile communication devices CD11, CD12, etc., associated with wireless station 131-1 do not transmit data in the uplink in time slot 31-5 of configuration frame 322. The mobile communication device CD21 would like to use wireless channel #4 during the time slot 31-5 to transmit in an uplink direction. The mobile communication device CD21 (i.e., wireless station) starts monitoring presence of energy in wireless channel #4 at time T75. Between time T75 and time T75-1, such as the listen before talk time, the mobile communication device CD21 detects that the wireless energy in the wireless channel #4 is lower than the ED threshold level for a predetermined amount of time as indicated by the listen before talk algorithm implemented by the mobile communication device CD21. As previously discussed, the mobile communication device CD21 is able to use the wireless channel #4 if not used by another wireless station. Because the wireless energy detected in the wireless channel #4 is below the ED threshold level for greater than a predetermined amount of time associated with the implemented clear channel assessment algorithm implemented by the mobile communication device CD21, the mobile communication device CD21 transmits its data (such as one or more data packets, symbols, etc.) in the uplink on wireless channel #4 to the wireless station 132-1 from time T75-1 to time T76. Thus, a time slot of wireless channel #4 that otherwise would not have been used by the service provider 121 and corresponding mobile communication device CD11, CD12, etc., is used by mobile communication device CD21.

Assume that the mobile communication device CD11 and mobile communication device CD21 both would like to use wireless channel #4 during the time slot 31-6 (between time T76 and time T77) to transmit in the uplink direction. As previously discussed, the mobile communication device CD11 has highest priority use of the wireless channel #4. In such an instance, the mobile communication device CD11 transmits its data in the uplink from the mobile communication device CD11 to the wireless station 131-1 between time T76 and time T77. Because the mobile communication device CD11 would like to transmit in time slot 31-6 as well, the mobile communication device wireless station 132-1 monitors use of the wireless channel #4 in time slot 31-6 between time T76 and time T77. When implementing listen before talk or clear channel assessment in the time slot 31-6, the mobile communication device CD11 detects that the magnitude of the energy in wireless channel #4 is above the energy threshold level for a duration of the time slot 31-6 such as because the mobile communication device CD11 is transmitting in the time slot 31-6 between time T76 and time T77. In this instance, the mobile communication device CD21 therefore does not transmit because it is assigned a lower priority level than other mobile communication devices associated with service provider 121 and because the channel #4 is used by another wireless station.

Assume that the mobile communication device CD11 does transmit data in the uplink in a portion of time slot 31-7. The mobile communication device CD21 would like to use wireless channel #4 during the time slot 31-7 to transmit in the uplink direction. The mobile communication device CD21 (i.e., wireless station) starts monitoring presence of energy in wireless channel #4 at time T77. Between time T77 and time T77-1, the mobile communication device CD21 detects that the wireless energy in the wireless channel #4 is higher than the ED threshold level. At time T77-1, the mobile communication device CD11 stops transmitting in time slot 31-7. The mobile communication device CD21 continues to monitor use of the wireless channel #4 after time T77-1. Starting from time T77-1, the mobile communication device CD21 detects that the energy (or power level) of received wireless communications between time T77-1 and time T77-2 is below the ED threshold level for a predetermined amount of time as indicated by the listen before talk algorithm implemented by the mobile communication device CD21.

As previously discussed, the mobile communication device CD21 is able to use the wireless channel #4 if not used by another wireless station. Because the wireless energy detected in the wireless channel #4 is below the ED threshold level for greater than a predetermined amount of time such as monitored between time T77-1 and T77-2, the mobile communication device CD21 transmits its data (such as one or more data packets, symbols, etc.) in the uplink on wireless channel #4 from time T77-2 to time T78. Thus, a remaining portion of a time slot of wireless channel #4 that otherwise would not have been used by the mobile communication device CD11, CD12, etc., is used by mobile communication device CD21.

In other words, via embodiments herein, shared use of the wireless channel #4 enables both the mobile communication device CD11 and mobile communication device CD21 to transmit data in different respective portions of the time slot 31-7.

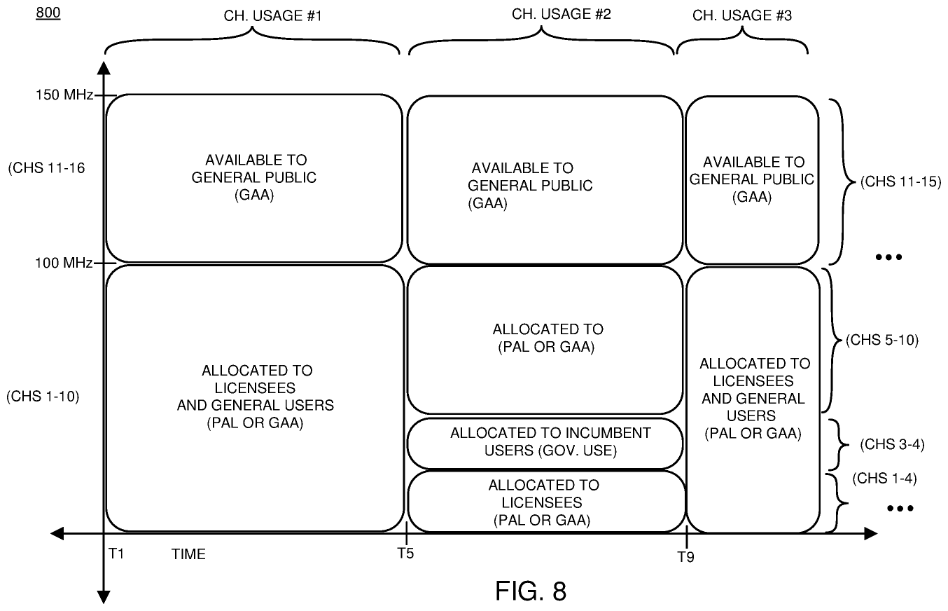

FIG. 8 is an example diagram illustrating generation of dynamic channel allocation information indicating allocation of spectrum at different tiers of a channel hierarchy according to embodiments herein.

As previously discussed, bandwidth manager 130 can be configured to assign any suitable type of wireless spectrum (spectrum, wireless channels, etc.) for use by the communication devices such as wireless base stations in the network environment 100.

In one non-limiting example embodiment, the bandwidth manager 130 and allocation management resource 141 allocate spectrum (wireless channels) from a so-called CBRS (Citizens Band Radio System) band operating between 3.550 and 3.700 GHz (GigaHertz) (such as 150 MegaHertz or 15 wireless channels that are each 10 MHz wide).

Also, as previously discussed, the allocation management resource 141 (such as spectrum access systems, allocation management resource, or other suitable entity) keeps track, at any given time, which wireless channels or portions of the multi-tier wireless spectrum or multi-tier radio band (such as CBRS band) are available in the geographical region in which the network environment 100 resides. If government use (such as use via a so-called incumbent user) is detected or requested via appropriate input (such as around time T5) to the allocation management resource 140, certain channels (such as those used by the general public) are no longer available for use.

More specifically, in this example, graph 800 indicates that between time T1 and time T5 (such as mode #1 or first condition), there is no indication detection of an incumbent user and thus licensed wireless channels 1-10 are available for use by licensed wireless user (and potentially unlicensed GAA users) for use; channels 11-15 are available for use by unlicensed GAA users. In a manner as previously discussed, these channels are allocated for use by the wireless base stations in network environment 100.

As further shown, at or around time T5, assume that the spectrum monitor 140 detects use of the wireless channels #3 and #4 by an incumbent user having higher priority than the PAL users and GAA users. In such an instance, the bandwidth monitor 140 notifies the spectrum allocation management resource 141 of such use prompting discontinued use of wireless channels #3 and #4. At or around time T9, the incumbent entity no longer uses wireless channels #3 and #4. In such an instance, the wireless channel #3 and #4 are again allocated for use by wireless stations in the network environment.

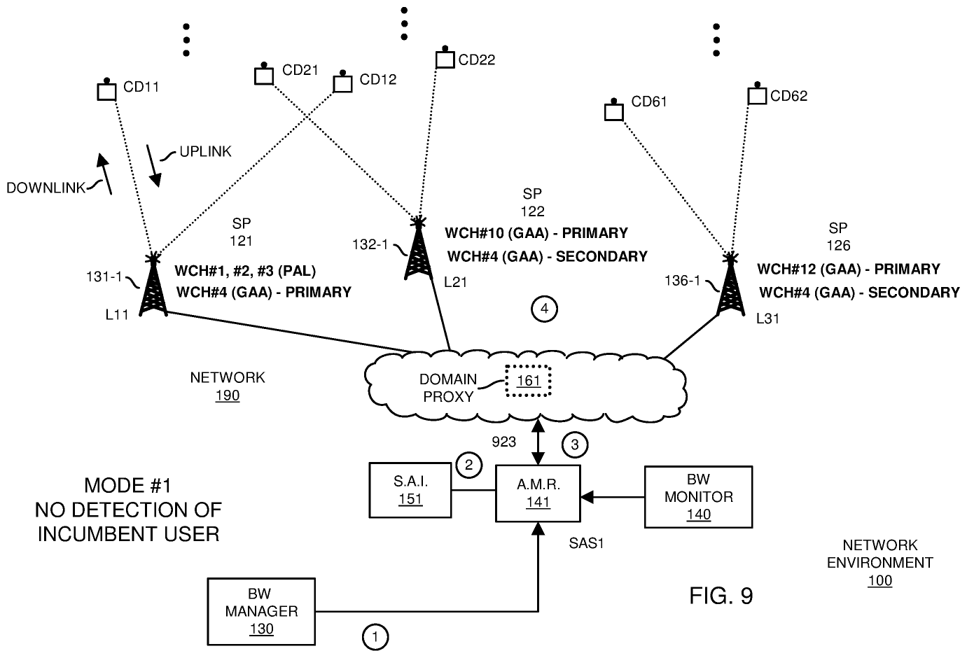

FIG. 9 is an example diagram illustrating a wireless network environment implementing hierarchical wireless spectrum allocation and shared use of certain wireless channels according to embodiments herein.

In this example embodiment, via communication 923 over network 190 to wireless stations 131-1, 132-1, etc., the allocation management resource 141 allocates use of the wireless bandwidth (wireless channels) in accordance with the spectrum allocation information 151.

For example, each of wireless base station 131-1 operated by wireless network service provider 121, wireless base station 132-1 operated by wireless network service provider 122, wireless base station 136-1 operated by wireless network service provider 126, etc., initially registers with the allocation management resource 141 for use of wireless channels.

As previously discussed, in accordance with the spectrum allocation information 151, because no incumbent entity is present in the network environment 100, the allocation management resource 141 allocates use of wireless channels #1, #2, and #3 (such as PAL wireless channels) to the wireless base stations 131-1 at location L11. The allocation management resource 141 also assigns uses of GAA wireless channel #4 to the wireless station 131-1 and corresponding service provider 121.

In this example embodiment, the wireless channel #4 is allocated in accordance with a hierarchical tier. For example, the wireless station 131-1 and corresponding service provider 121 are assigned as a primary user of the wireless channel #4. As a primary user, the corresponding service provider 121 and wireless station 131-1 have higher priority rights to use the wireless channel #4 than any secondary users as further discussed below.

Additionally, each of the one or more wireless base station 132-1 operated by the second wireless network service provider 122 registers with the allocation management resource 141 for use of wireless channels. Because no incumbent entity is present, the allocation management resource 141 allocates use of wireless channel #10 to the wireless base station 132-1 and corresponding service provider 122. The wireless station 132-1 or other suitable entity notifies the allocation management resource 141 that it (and corresponding mobile communication device (CD21, CD22, etc.) supports channel sensing and monitoring (such as listen before talk, clear channel assessment, etc.) on wireless channels #4, #5, #11, #12, #13, #14, and #15. The wireless station 132-1 is therefore a candidate to share use of one or more of these GAA wireless channels assigned to one or more other wireless stations (or service providers). In one embodiment, the wireless station 132-1 registers with a allocation management resource 141 (such as SAS) indicating its channel sensing capability in wireless channels #4, #5, #11, #12, #13, #14, and #15. In such an instance, because the wireless station 132-1 requests additional bandwidth, and because it supports channel sensing on wireless channel #4, the allocation management resource 141 also assigns use of GAA wireless channel #4 to the wireless station 132-1 (as a secondary user) and corresponding service provider 122.

Additionally, each of the one or more wireless base station 136-1 operated by the sixth wireless network service provider 126 registers with the allocation management resource 141 for use of wireless channels. Because no incumbent entity is present, the allocation management resource 141 allocates use of wireless channel #12 to the wireless base station 136-1 and corresponding service provider 126. The wireless station 136-1 or other suitable entity notifies the allocation management resource 141 that it (and corresponding mobile communication device (CD61, CD62, etc.) supports channel sensing and monitoring (such as listen before talk, clear channel assessment, etc.) on wireless channels #4, #5, #10, #11, #13, #14, and #15. The wireless station 136-1 is therefore a candidate to share use of one or more of these GAA wireless channels assigned to one or more other wireless stations (or service providers). In one embodiment, the wireless station 136-1 registers with the allocation management resource 141 (such as SAS) indicating its channel sensing capability in wireless channels #4, #5, #10, #11, #13, #14, and #15. In such an instance, because the wireless station 136-1 requests additional bandwidth, and because it supports channel sensing on wireless channel #4, the allocation management resource 141 also assigns use of GAA wireless channel #4 to the wireless station 136-1 (as a secondary user) and corresponding service provider 126.

In one embodiment, the allocation management resource 141 receives feedback from wireless stations indicating actual usage of each of the allocated wireless channels. The allocation management resource uses the usage information as a basis to identify which wireless channels are good candidates to share amongst multiple users. In one embodiment, the allocation management resource detects that the wireless channel #4 is not fully used by the primary wireless station 131-1. In such an instance, because the wireless channel #4 is not fully used by the wireless station 131-1 and corresponding service provider 121, the allocation management resource 141 allocates use of the wireless channel #4 to the wireless station 132-1 and wireless station 136-1.

In this example embodiment, as previously discussed, the wireless channel #4 is allocated in accordance with a tiered hierarchy. For example, the wireless station 132-1 and corresponding service provider 122 as well as wireless station 136-1 and corresponding wireless network service provider 126 are assigned as secondary users of the wireless channel #4. As a secondary user, as further discussed herein, the corresponding service provider 122 and wireless station 132-1 have lower priority rights to use the wireless channel #4 than primary user (such as service provider 121 and wireless station 131-1). As a secondary user, as further discussed herein, the corresponding service provider 126 and wireless station 136-1 have lower priority rights to use the wireless channel #4 than primary user (such as service provider 121 and wireless station 131-1). Second users have equal rights to use wireless channel #4. Accordingly, embodiments herein include implementing a multiple level tiered hierarchy. In other words, as further discussed herein, the secondary users (i.e., corresponding service provider 122 and wireless station 132-1 or service provider 126 and wireless station 136-1) are able to use the wireless channel #4 only if it is not used by the service provider 121 and corresponding wireless station 131-1 or each other.

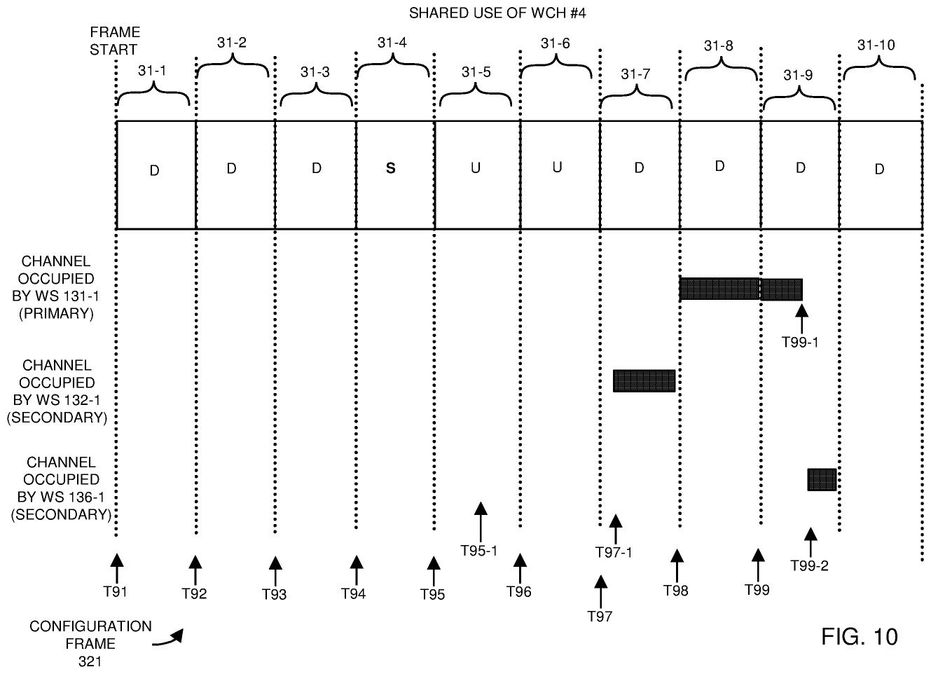

FIG. 10 is an example diagram illustrating shared use of a wireless channels according to embodiments herein.

In this embodiment, at or around time T95-1, the wireless station 132-1 and wireless station 136-1 both would like to transmit data in a respective downlink direction. Neither wireless station is able to transmit in the downlink in time slot 31-5 and time slot 31-6 allocated for uplink communications.

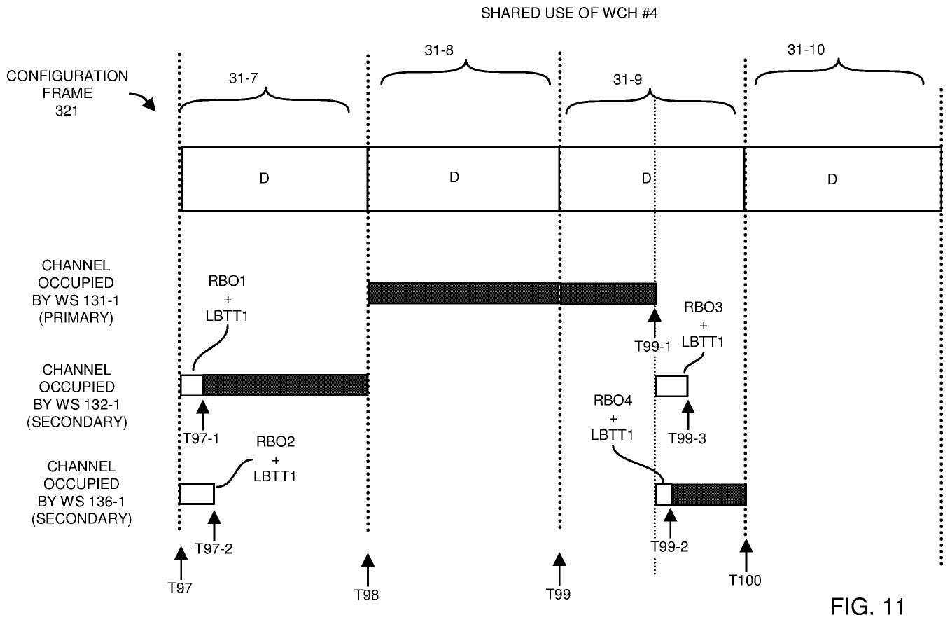

In a similar manner as previously discussed, any secondary user (such as wireless station 132-1 or wireless station 136-1 is able to transmit in the downlink if it is not used by the wireless station 131-1. As further shown and discussed with respect to FIG. 11, each of the wireless stations is able to transmit data in the downlink at different times. For example, the wireless station 132-1 transmit data in time slot 31-7; the wireless station 136-1 transmits data in time slot 31-9.

If desired, each of the secondary users can be configured to implement different random back-off times such that both the wireless station 132-1 and the wireless station 136-1 do not transmit at the same time when implementing the clear channel assessment (or listen before talk) algorithm. In one embodiment, the secondary users can be configured to implement the different random back-off times in response to detecting a collision in which both wireless stations attempt to communicate in a same time slot not used by the wireless station 131-1 (primary user).

FIG. 11 is an example diagram illustrating implementation of random back-off times by one or more wireless stations according to embodiments herein.

In this example embodiment, each of the secondary users such as wireless stations 132-1 and wireless station 136-1 implement different random back-off time times. For example, in time slot 31-7, the wireless station 132-1 implements random back-off time RBO1; in time slot 31-7, wireless station 136-1 implements random back-off time RBO2. Both secondary users (wireless station 132-1 and wireless station 136-1) implement a listen before talk time of LBTT1 associated with the listen before talk protocol used to acquire the wireless channel #4.

In this example embodiment, the wireless station 131-1 does not communicate in time slot 31-7. In such an instance, the wireless station 132-1 and wireless station 136-1 compete to use the wireless channel #4 in time slot 31-7. Assume that the random back-off time RBO1 is less than random back-off time RBO2. In such an instance, the wireless station 132-1 acquires the wireless channel #4 before wireless station 136-1. Wireless station 132-1 communicates in the downlink in time slot 31-7 of acquired wireless channel #4.

Further in this example embodiment, the wireless station 131-1 does transmit in time slot 31-8. In such an instance, even though the wireless station 132-1 and wireless station 136-1 monitor availability of wireless channel #4, neither are able to use wireless channel #4 in time slot 31-8 because they detect presence of energy above the ED threshold level.

The wireless station 131-1 does transmit in a first portion of the time slot 31-8. In such an instance, even though the wireless station 132-1 and wireless station 136-1 monitor availability of wireless channel #4, neither are able to use wireless channel #4 in the first portion of time slot 31-8 between time T99 and T99-1. At time T99-1, the wireless station 131-1 discontinues use of the wireless channel #4. Wireless station 132-1 implements random back-off time RB 03; wireless station implements random back-off time RBO4, where RBO4 is less than RBO3. Assume that the random back-off time RBO4 is less than random back-off time RBO3.

At time T99-2, the wireless station 136-1 detects that wireless energy in the wireless channel #4 is below an ED threshold level for duration (RBO4+LBBTT1) between time T99-1 and T99-2. In such an instance, the wireless station 136-1 acquires wireless channel #4 for the remaining portion of the time slot 31-9 and transmits between T99-2 and T99-3. The wireless station 132-1 detects use of the wireless channel #4 by wireless station 136-1 before time T99-3 and refrains from communicating over the wireless channel #4, preventing interference.

Accordingly, embodiments herein support semi-slotted access in each of multiple timeslots.

Clear channel assessment can be done at any time. However, after successful determination that the channel is clear, channel access is contained within the slot period recognized by the allocation management resource (spectrum access system) such as for example 0.5 millisecond or other suitable amount.

As previously discussed, transmission from a respective wireless station can only be done in the direction (uplink or downlink) determined by SAS/CxM based on the allowed TDD frame configurations for the CBSD.

A clear channel assessment must be performed in each time slot before resuming data transmission from a wireless station.

If clear channel assessment fails, the device does not transmit and waits until next slot to monitor again.

As previously discussed, embodiments herein include implementing a random backoff counter in each wireless station, which is used at the start of the next slot for CCA to ensure good coexistence among CS based devices which are frame synchronized. Note that the random backoff makes the access different from conventional frame based equipment (FBE) access which is based on a fixed frame period.

In further example embodiments, License Assisted Access (LAA) can be implemented to allow a respective wireless station to maintain sync/timing using a conventional licensed or unlicensed cell.

Note that any of one or more wireless channels can be accessed by multiple secondary wireless stations sharing use of the wireless channel with a primary user.

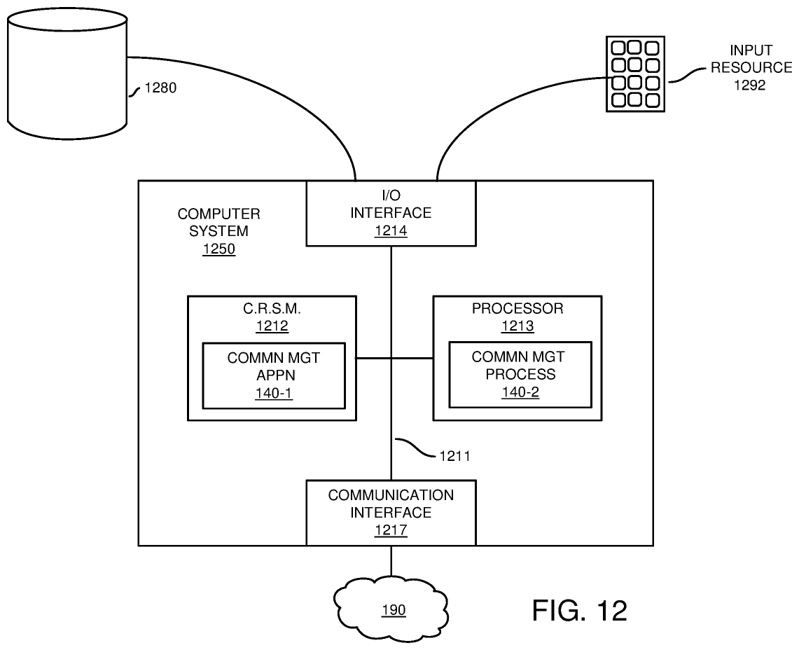

FIG. 12 is an example block diagram of a computer system for implementing any of the operations as previously discussed according to embodiments herein.

Any of the resources (such as communication management resource, allocation management resource 141, allocation management resource 142, bandwidth monitor 130, bandwidth manager 140, wireless station 131-1, wireless station 132-1, etc.) as discussed herein can be configured to include computer processor hardware and/or corresponding executable instructions to carry out the different operations as discussed herein.

As shown, computer system 1250 of the present example includes an interconnect 1211 that couples computer readable storage media 1212 such as a non-transitory type of media (which can be any suitable type of hardware storage medium in which digital information can be stored and retrieved), a processor 1213 (computer processor hardware), I/O interface 1214, and a communications interface 1217.

I/O interface(s) 1214 supports connectivity to repository 1280 and input resource 1292.

Computer readable storage medium 1212 can be any hardware storage device such as memory, optical storage, hard drive, floppy disk, etc. In one embodiment, the computer readable storage medium 1212 stores instructions and/or data.

As shown, computer readable storage media 1212 can be encoded with communication management application 140-1 (e.g., including instructions) to carry out any of the operations as discussed herein.

During operation of one embodiment, processor 1213 accesses computer readable storage media 1212 via the use of interconnect 1211 in order to launch, run, execute, interpret or otherwise perform the instructions in management application 140-1 stored on computer readable storage medium 1212. Execution of the communication management application 140-1 (such as implemented by allocation management resource 141, wireless stations, etc.) produces communication management process 140-2 to carry out any of the operations and/or processes as discussed herein.

Those skilled in the art will understand that the computer system 1250 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

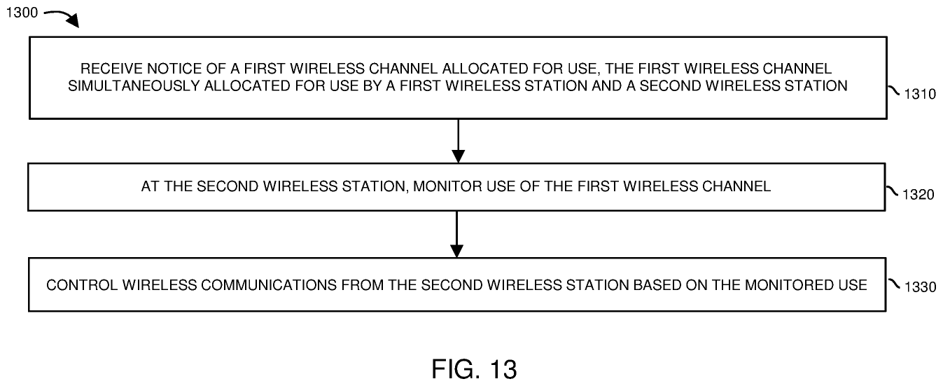

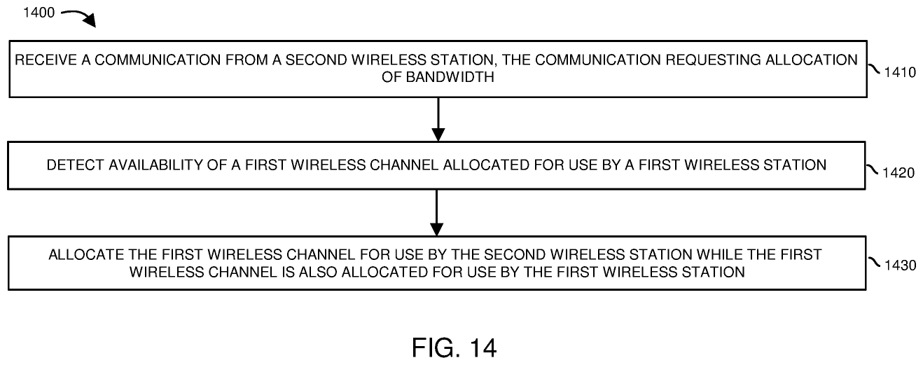

Functionality supported by the different resources will now be discussed via flowcharts in FIGS. 13 and 14. Note that the steps in the flowcharts below can be executed in any suitable order.

FIG. 13 is a flowchart 1300 illustrating an example method according to embodiments. Note that there will be some overlap with respect to concepts as discussed above.

In processing operation 1310, the service provider 122 and/or wireless station 132-1 receives notice of a first wireless channel allocated for use by wireless station 132-1, the first wireless channel is allocated for use by both the wireless station 132-1 and wireless station 131-1.

In processing operation 1320, at the wireless station 132-1, monitor use of the first wireless channel.

In processing operation 1330, control wireless communications from the first wireless station 132-1 based on the monitored use.

FIG. 14 is a flowchart 1400 illustrating an example method according to embodiments. Note that there will be some overlap with respect to concepts as discussed above.

In processing operation 1410, the allocation management resource 141 receives a communication from wireless station 132-1. The communication requests allocation of bandwidth.

In processing operation 1420, the allocation management resource 141 detects availability of a wireless channel #4 allocated for use by wireless station 131-1.

In processing operation 1430, the allocation management resource 141 allocates the wireless channel #4 for use by the wireless station 132-1 while the wireless channel #4 is also allocated for use by the wireless station 131-1.

Note again that techniques herein are well suited to facilitate shared use of wireless channels in a hierarchical wireless spectrum allocation system. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving notice of a first wireless channel allocated for use, the first wireless channel allocated for use by a first wireless station and a second wireless station;
at the second wireless station, monitoring use of the first wireless channel; and
controlling wireless communications from the second wireless station based on the monitored use.

2. The method as in claim 1, wherein controlling wireless communications from the second wireless station based on the monitored use includes:
at the second wireless station:
preventing wireless transmission of a first communication from the second wireless station in response to detecting use of the first wireless channel by another wireless station.

3. The method as in claim 1, wherein controlling wireless communications from the second wireless station based on the monitored use includes:
at the second wireless station:
wirelessly transmitting a first communication from the second wireless station in response to detecting non-use of the first wireless channel by another wireless station.

4. The method as in claim 1, wherein the first wireless channel is allocated from a tiered hierarchy of wireless channels in which different service providers are assigned different usage priority levels of the wireless channels.

5. The method as in claim 1, wherein the first wireless station is assigned a higher priority than the second wireless station to use the first wireless channel.

6. The method as in claim 1, wherein monitoring use of the first wireless channel includes: i) at the second wireless station, monitoring a power level of receiving communications over the first wireless channel; and ii) comparing the power level to a threshold level; and
wherein controlling the wireless communications from the second wireless station includes: wirelessly transmitting a communication from the second wireless station over the first wireless channel in response to detecting that the power level is below the threshold level.

7. The method as in claim 1 further comprising:
synchronizing the second wireless station to a time-division time slot configuration implemented by the first wireless station to communicate over the first wireless channel.

8. The method as in claim 1, wherein monitoring use of the first wireless channel includes:
implementing a random back-off time for monitoring during a time slot of a time-division time slot configuration used by the first wireless station to communicate over the first wireless channel.

9. The method as in claim 1, wherein monitoring use of the first wireless channel includes: detecting presence of energy in the first wireless channel above a threshold level in a first portion of a time slot; and
wherein controlling wireless communications from the second wireless station based on the monitored use includes: in response to detecting presence of the energy in the first wireless channel above the threshold level in the first portion of the time slot, preventing communications over the first wireless channel during the first portion of the time slot.

10. The method as in claim 9, wherein monitoring use of the first wireless channel includes: detecting presence of energy in the first wireless channel below a threshold level in a second portion of the time slot; and
wherein controlling wireless communications from the second wireless station based on the monitored use includes: in response to detecting presence of the energy in the first wireless channel below the threshold level in the second portion of the time slot, transmitting a wireless communication from the second wireless station over the first wireless channel during the second portion of the time slot.

11. A method comprising:
receiving a communication requesting allocation of bandwidth;
detecting availability of a first wireless channel allocated for use by a first wireless station; and
allocating the first wireless channel for use by a second wireless station while the first wireless channel is also allocated for use by the first wireless station.

12. The method as in claim 11 further comprising:
allocating the first wireless channel from a tiered hierarchy of wireless channels in which different service providers are assigned different usage priority levels of the wireless channels.

13. The method as in claim 12, wherein the first wireless station is assigned a higher priority than the second wireless station to use the first wireless channel.

14. The method as in claim 11 further comprising:
providing notification to the second wireless station of a time-division time slot configuration implemented by the first wireless station to communicate over the first wireless channel.

15. The method as in claim 11 further comprising:
allocating the first wireless channel to the second wireless station in response to detecting that the second wireless station supports wireless power monitoring of the first wireless channel.

16. A system comprising:
communication management hardware operative to:
receive notice of a first wireless channel allocated for use, the first wireless channel allocated for use by a first wireless station and a second wireless station;
monitor use of the first wireless channel; and
control wireless communications from the second wireless station based on the monitored use.

17. The system as in claim 16, wherein the communication management hardware is further operative to:
prevent wireless transmission of a first communication from the second wireless station in response to detecting use of the first wireless channel by another wireless station.

18. The system as in claim 16, wherein the communication management hardware is further operative to:
wirelessly transmit a first communication from the second wireless station in response to detecting non-use of the first wireless channel by another wireless station.

19. The system as in claim 16, wherein communication management hardware is further operative to:
allocate the first wireless channel from a tiered hierarchy of wireless channels in which different service providers are assigned different usage priority levels of the wireless channels.

20. The system as in claim 16, wherein the first wireless station is assigned a higher priority than the second wireless station to use the first wireless channel.

21. The system as in claim 16, wherein the communication management hardware is further operative to:
monitor a power level of receiving communications over the first wireless channel;
compare the power level to a threshold level; and
wirelessly transmit a communication from the second wireless station over the first wireless channel in response to detecting that the power level is below the threshold level.

22. The system as in claim 16, wherein the communication management hardware is further operative to:
synchronize the second wireless station to a time-division time slot configuration also used by the first wireless station.

23. The system as in claim 16, wherein the communication management hardware is further operative to:
implement a random back-off time for monitoring during a time slot of a time-division time slot configuration implemented by the first wireless station to communicate over the first wireless channel.

24. The system as in claim 16, wherein the communication management hardware is further operative to:
detect presence of energy in the first wireless channel above a threshold level in a first portion of a time slot; and
wherein controlling wireless communications from the second wireless station based on the monitored use includes: in response to detecting presence of the energy in the first wireless channel above the threshold level in the first portion of the time slot, preventing transmission of communications from the second wireless station over the first wireless channel during the first portion of the time slot.

25. The system as in claim 24, wherein the communication management hardware is further operative to:
detect presence of energy in the first wireless channel below a threshold level in a second portion of the time slot; and
in response to detecting presence of the energy in the first wireless channel below the threshold level in the second portion of the time slot, transmitting a wireless communication over the first wireless channel during the second portion of the time slot.

26. A system comprising:
communication management hardware operative to:
receive a communication requesting allocation of bandwidth;
detect availability of a first wireless channel allocated for use by a first wireless station; and
allocate the first wireless channel for use by a second wireless station while the first wireless channel is also allocated for use by the first wireless station.

27. The system as in claim 26, wherein the communication management hardware is further operative to:
allocate the first wireless channel from a tiered hierarchy of wireless channels in which different service providers are assigned different usage priority levels of the wireless channels.

28. The system as in claim 27, wherein the first wireless station is assigned a higher priority than the second wireless station to use the first wireless channel.

29. The system as in claim 26, wherein the communication management hardware is further operative to:
providing notification to the second wireless station of a time-division time slot configuration implemented by the first wireless station to communicate over the first wireless channel.

30. The system as in claim 26, wherein the communication management hardware is further operative to:
allocate the first wireless channel to the second wireless station in response to detecting that the second wireless station supports wireless power monitoring of the first wireless channel.

31. Computer-readable storage hardware having instructions stored thereon, the instructions, when carried out by computer processor hardware, cause the computer processor hardware to:
receive notice of a first wireless channel allocated for use, the first wireless channel allocated for use by a first wireless station and a second wireless station;
at the second wireless station, monitor use of the first wireless channel; and
control wireless communications from the second wireless station based on the monitored use.
